(19) United States
(12) Patent Application Publication
(10) Pub. No.: US 2004/0137166 A1
(43) Pub. Date: Jul. 15, 2004

(54) Cationic coating composition and coating film-forming method

(76) Inventors: Shigeo Nishiguchi, Kanagawa-ken (JP); Koji Kamikado, Kanagawa-ken (JP); Hideki Iijima, Kanagawa-ken (JP); Akihiko Shimasaki, Kanagawa-ken (JP); Tadayoshi Hiraki, Kanagawa-ken (JP)

Correspondence Address: FISHER, CHRISTEN & SABOL, 1725 K STREET, N.W., SUITE 1108, WASHINGTON, DC, 20006, US

(21) Appl. No.: 10/721,429

(22) Filed: Nov. 26, 2003

(30) Foreign Application Priority Data
Nov. 26, 2002 (JP) 02/342745
Nov. 19, 2003 (JP) 03/389926

(51) Int. Cl. B05D 1/36; B05D 7/14

(52) U.S. Cl. 427/508; 427/407.1; 205/224

(57) ABSTRACT

A cationic coating composition containing (A) an unsaturated group-modified cationic epoxy resin, (B) a blocked polyisocyanate crosslinking agent, and (C) a photopolymerization initiator, preferably further containing a polymerizable unsaturated group-containing compound (D).

### BACKGROUND OF THE INVENTION

(1) Field of the Invention

The present invention relates to a cationic coating composition, a mono-layer coating film-forming method comprising subjecting a cationic electrodeposition coating composition as the cationic coating composition to an electrodeposition coating to form an electrodeposition coating film, followed by subjecting the electrodeposition coating film to both irradiation and heating to form a cured mono-layer coating film, a multi-layer coating film-forming method comprising coating the cationic coating composition to form a cationic coating film, followed by subjecting the cationic coating film to irradiation only, coating an intercoat coating composition and/or a topcoat coating composition to form an intercoat coating film and/or a topcoat coating film, and simultaneously heating and curing the cationic coating film, and the intercoat coating film and/or the topcoat coating film, and a coated product obtained by the above methods.

(2) Description of Background Art

In the field of the automobile coating, various kinds of developments and approaches have been proposed from the standpoints of an optimization of a production cost and a measure to cope with the environment.

In the production cost optimization, for the purpose of providing a cheap product to a user, approaches to improvements in production cost, for example, reviews of automobile body production steps such as reduction in steps, energy saving, reduction in space, tact up, an integrated coating of a plastic part and steel plate and the like, reduction in a starting material cost and the like, have been proposed.

As measures to cope with the environment, studies in the production environment, for example, provision of a water based or powder intercoat coating composition and topcoat coating composition, and deletion of the intercoat coating composition for the purpose of reducing an exhaust gas, gum and soot from a drying oven, and reducing a volatile organic compound have been made, and in the case of the product environment, provision of an electrodeposition coating film free of a harmful metal such as lead, tin and the like has been promoted.

International Patent Application Laid-Open No. 99/125660 discloses a coating method which comprises coating a cationic electrodeposition coating composition, followed by coating an intercoat coating, composition by a wet∘on∘wet coating method for the purpose of reduction in steps and energy savings (Patent Reference 1).

However, the wet∘on∘wet coating of the intercoat coating composition onto the cationic electrodeposition coating film develops mixing between the electrodeposition coating film and the intercoat coating film, resulting in reducing finish properties and corrosion resistance.

Japanese Patent Application Laid-Open No. 241533 discloses a photocurable putty used in an automobile repair, containing bisphenol A type epoxy di(meth)acrylate and capable of forming a cured coating film by a photopolymerization reaction (Patent Reference 2). However, a satisfactory curing can not be achieved by photo-curing only, resulting in unsatisfactory properties in finish properties and corrosion resistance.

A coating composition containing an acrylic resin having a functional group reactive with light, and a heat-curable curing agent is disclosed in Japanese Patent Application Laid-Open No. 11169/89 (Patent Reference 3). However, the above coating composition can not be subjected to an electrodeposition coating and may result unsatisfactory corrosion resistance due to the use of the acrylic resin.

In view of the above background, provision of a cationic coating composition, and a multi-layer coating film-forming method using an intercoat coating composition and/or a topcoat coating composition in addition to the cationic coating composition, which make possible the optimization of a production cost, for example, reduction in steps and energy savings by omission of heating and drying oven and heating step as well as good properties in finish properties and corrosion resistance, has been demanded.

### SUMMARY OF THE INVENTION

It is an object of the present invention to provide a cationic coating composition, and a method of forming a mono-layer electrodeposition coating film or a multi-layer coating film by use of the cationic coating composition, which are capable of achieving reduction in steps, optimization of production cost and measures to cope with the environment.

The present inventors made intensive studies for the purpose of solving the problems in the art to find out a cationic coating composition containing an unsaturated group-modified cationic epoxy resin (A), a blocked polyisocyanate crosslinking agent (B) and a photopolymerization initiator (C), a mono-layer coating film-forming method which comprises subjecting a cationic electrodeposition coating film to irradiation and heating to obtain a cured mono-layer coating film, and a multi-layer coating film-forming method, which comprises subjecting a cationic coating film to irradiation only, followed by coating an intercoat coating composition and/or a topcoat coating composition, and simultaneously heating and curing the resulting multi-layer coating film, resulting in accomplishing the present invention.

That is, the present invention provides

1. A cationic coating composition containing (A) an unsaturated group-modified cationic epoxy resin, (B) a blocked polyisocyanate crosslinking agent, and (C) a photopolymerization initiator,

2. A cationic coating composition as defined in paragraph 1, wherein the unsaturated group-modified cationic epoxy resin (A) is obtained by reacting an epoxy resin (a) having an epoxy equivalent of 180 to 2500 with an unsaturated group-containing compound (b) and a cationic group-containing compound (c),

3. A cationic coating composition as defined in paragraph 1, wherein the unsaturated group-modified cationic epoxy resin (A) has an unsaturated group equivalent of 6000 or less,

4. A cationic coating composition as defined in paragraph 1, wherein the epoxy resin (a) in the unsaturated group-modified cationic epoxy resin (A) is obtained by reacting a polyphenol compound and an epihalohydrin,

5. A cationic coating composition as defined in paragraph 1, wherein the cationic coating composition further contains a polymerizable unsaturated group-containing compound (D),

6. A mono-layer coating film-forming method, which comprises subjecting a cationic electrodeposition coating composition as the cationic coating composition as defined in any one of paragraphs 1 to 5 to an electrodeposition coating to form an electrodeposition coating film, followed by subjecting the electrodeposition coating film to both irradiation and heating to form a cured mono-layer coating film,

7. A multi-layer coating film-forming method which comprises the following successive steps (1) to (4):

a step (1) of coating the cationic coating composition as defined in any one of paragraphs 1 to 5 onto a coating substrate to form a cationic coating film,

a step (2) of subjecting the cationic coating film formed in the step (1) to irradiation,

a step (3) of coating an intercoat coating composition and/or a topcoat coating composition to form an intercoat coating film and/or a topcoat coating film, and

a step (4) of simultaneously heating and curing the cationic coating film, and the intercoat coating film and/or the topcoating film,

8. A multi-layer coating film-forming method as defined in paragraph 7, wherein the cationic coating film formed by the step (1) in paragraph 7 is preheated at a temperature of 60 to 120° C.,

9. A multi-layer coating film-forming method as defined in paragraph 7, wherein the cationic coating composition is a cationic electrodeposition coating composition, and

10. A coated product obtained by any one of the methods as defined in paragraphs 6 to 9.

### DETAILED DESCRIPTION OF THE INVENTION

The present invention relates to a cationic coating composition, a mono-layer coating film-forming method which comprises subjecting a mono-layer cationic electrodeposition coating film to irradiation and heating to form a cured film, and a multi-layer coating film-forming method which comprises subjecting a cationic coating film to irradiation only, followed by coating an intercoat coating composition and/or a topcoat coating composition to form an intercoat coating film and/or a topcoat coating film, and simultaneously heating and curing the resulting multi-layer coating film, which make possible optimization of production cost, for example, reduction in steps by omission of heating and drying oven and heating step, and energy saving for the electrodeposition coating film, reduction in gum and soot from the drying oven as measure to environment, and good properties in corrosion resistance and finish properties.

Cationic Coating Composition

The cationic coating composition of the present invention contains an unsaturated group-modified cationic coating composition (A), a blocked polyisocyanate crosslinking agent (B) and a photopolymerization initiator (C), and preferably a polymerizable unsaturated group-containing compound (D).

Unsaturated Group-Modified Cationic Epoxy Resin (A):

The epoxy resin (a) used in the unsaturated group-modified cationic epoxy resin (A) may preferably include, from the standpoint of corrosion resistance of the coating film, an epoxy resin prepared by reaction of a polyphenol compound with an epihalohydrin such as epichlorohydrin.

The polyphenol compound used for obtaining the epoxy resin may include ones known in the art, for example, bis(4-hydroxyphenyl)-2,2-propane (bisphenol A), 4,4-dihydroxybenzophenone, bis(4-hydroxyphenyl)methane (bisphenol F), bis(4-hydroxyphenyl)-1,1-ethane, bis(4-hydroxyphenyl)-1,1-isobutane, bis (4-hydroxy-tert-butyl-phenyl)-2,2-propane, bis(2-hydroxynaphthyl)methane, tetra(4-hydroxyphenyl)-1,1,2,2-ethane, 4,4-dihydroxydiphenylsulfone (bisphenol S), phenol novolak, cresol novolak, and the like.

The epoxy resin obtained by the reaction of the polyphenol compound with epichlorohydrin may particularly include ones derived from bisphenol A and represented by the following formula:

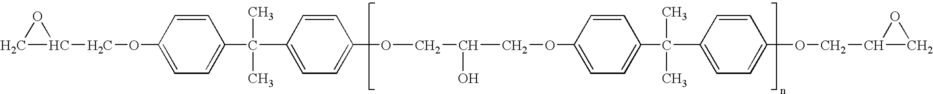

where n is 0 to 8.

The epoxy resin (a) has an epoxy equivalent in the range of 180 to 2,500, preferably 200 to 2,000, and a number average molecular weight in the range of at least 200, particularly 400 to 4,000, more particularly 800 to 2,500.

Examples of commercially available trade names of the epoxy resin may include Epikote 828 EL, Epikote 1002, Epikote 1004 and Epikote 1007 (trade names marketed by Japan Epoxy Resin Co., Ltd.).

Unsaturated Group-Containing Compound (b):

An unsaturated group may be introduced into the epoxy resin by addition of the unsaturated group-containing compound (b) to the epoxy resin (a).

The unsaturated group-containing compound (b) may include, for example, a carboxyl group-containing unsaturated monomer such as acrylic acid, methacrylic acid, crotonic acid, itaconic acid, maleic acid, fumaric acid and the like; a hydroxyl group-containing unsaturated monomer such as 2-hydroxyethyl (meth)acrylate, 2-hydroxypropyl (meth)acrylate, 4-hydroxybutyl (meth)acrylate, adducts of 2-hydroxyethyl (meth)acrylate with caprolactone, for example, Placcel FA-2, Placcel FM-3 (trade names, marketed by Daicel Chemical Industries, Ltd., respectively) and the like, and an adduct thereof with a diisocyanate compound such as tolylene diisocyanate, 4,4′-diphenylmethane diisocyanate, xylylene diisocyanate, hexamethylene diisocyanate, isophorone diisocyanate, 4,4′-methylenebiscyclohexyl isocyanate and the like. Of these, the mono-adduct with the diisocyanate compound is preferable from the standpoint of a degree of freedom on synthesis.

Cationic Group-Containing Compound (c):

The cationic group-containing compound (c) is a compound containing a cationic group such as amino group, ammonium salt group, sulfonium salt group, phosphonium salt group and the like. Of these, amino-group is preferable from the standpoint of water dispersibility. The amino group may be introduced into the epoxy resin by addition of the amino group-containing compound to the epoxy resin.

The amino group-containing compound is a cationic properties-imparting component which introduces amino group into the epoxy resin base and cationizes the epoxy resin, and may include one having at least one active hydrogen to react with epoxy group.

The amino group-containing compound used for the above purpose may include, for example, mono- or di-alkylamine such as monomethylamine, dimethylamine, monoethylamine, diethylamine, monoisopropylamine, diisopropylamine, monobutylamine, dibutylamine and the like; alkanolamine such as monoethanolamine, diethanolamine, mono(2-hydroxypropyl)amine, di(2-hydroxypropyl)amine, tri(2-hydroxypropyl)amine, monomethylaminoethanol, monoethylaminoethanol and the like; alkylene polyamine such as ethylenediamine, propylenediamine, butylenediamine, hexamethylenediamine, tetraethylenepentamine, pentaethylenehexamine, diethylaminopropylamine, diethylenetriamine, triethylenetriamine and the like, and a ketiminized product of these polyamines; an alkyleneimine such as ethyleneimine, propyleneimine and the like; a cyclic amine such as piperazine, morpholine, pyrazine and the like, and the like.

Mixing ratios of the unsaturated group-containing compound (b) and the cationic group-containing compound (c) as the reaction components relative to the epoxy resin (a) are not specifically limited and may arbitrarily be varied depending on uses of the coating composition, but are preferably such that the epoxy resin (a) is in the range of 50 to 90% by weight, preferably 55 to 85% by weight, the unsaturated group-containing compound (b) is in the range of 0.5 to 30% by weight, preferably 1 to 25% by weight, and the cationic group-containing compound (c) is in the range of 3 to 30% by weight, preferably 5 to 30% by weight based on a total solid content of the epoxy resin (a), the unsaturated group-containing compound (b) and the cationic group-containing compound (c).

The above addition reaction may be carried out in a suitable solvent under the conditions of about 80° C. to about 170° C., preferably about 90° C. to about 150° C. and 1 to 6 hours, preferably about 1 to 5 hours. The above solvent may include, for example, hydrocarbons such as toluene, xylene, cyclohexane, n-hexane and the like; esters such as methyl acetate, ethyl acetate, butyl acetate and the like; ketones such as acetone, methyl ethyl ketone, methyl isobutyl ketone, methyl amyl ketone and the like; amides such as dimethyl formamide, dimethyl acetamide and the like; alcohols such as methanol, ethanol, n-propanol, iso-propanol and the like.

The unsaturated group-modified cationic epoxy resin (A) obtained as above has an unsaturated group equivalent of 6,000 or less, preferably 500 to 5,000. The unsaturated group-modified cationic epoxy resin (A) may also be plasticized and modified. An epoxy resin-plasticizing modifier may include ones having a good compatibility with the epoxy resin and hydrophobic properties.

An amount of the modifier used for plasticization must be in a minimum amount necessary for plasticization, and is in the range of 3 to 40 parts by weight, preferably 5 to 30 parts by weight per 100 parts by weight of the epoxy resin. The modifier may preferably include, for example, ones having reactivity with epoxy group such as xylene formaldehyde resin, polycaprolactone polyol and the like.

Blocked Polyisocyanate Crosslinking Agent (B)

The blocked polyisocyanate crosslinking agent (B) is an addition reaction product in a chemically equivalent amount between a polyisocyanate compound and a blocking agent.

The polyisocyanate compound may include, for example, aromatic, aliphatic or alicyclic polyisocyanate compound such as tolylene diisocyanate, xylene diisocyanate, phenylene diisocyanate, diphenylmethane-2,4′-diisocyanate, diphenylmethane-4,4′-diisocyanate (or MDI), crude MDI, bis(isocyanatomethyl)cyclohexane, tetramethylene diisocyanate, hexamethylene diisocyanate, methylene diisocyanate, isophorone diisocyanate and the like; a cyclic polymerization product of these polyisocyanate compounds, isocyanate biuret type adducts, a terminal isocyanate-containing compound obtained by reacting an excess amount of these polyisocyanate compounds with a low molecular active hydrogen-containing compound such as ethylene glycol, propylene glycol, trimethylolpropane, hexane triol, castor oil and the like, and the like. These may be used alone or in combination.

The blocking agent is such that addition of the blocking agent to an isocyanate group in the polyisocyanate compound blocks the isocyanate group, and a resulting blocked polyisocyanate compound is stable at normal temperatures, but heating at a heat-curing temperature usually in the range of about 100° C. to 200° C. may dissociate the blocking agent to regenerate a face isocyanate group.

The blocking agent to satisfy the above requirements may include, for example, a lactam based compound such as ε-caprolactam, γ-butylolactam and the like; an oxime compound such as methylethylketoxime, cyclohexanoneoxime and the like; phenol based compound such as phenol, p-t-butylphenol, cresol and the like; aliphatic alcohols such as n-butanol, 2-ethylhexanol and the like; aromatic alkyl alcohols such as phenyl carbitol, methylphenyl carbitol and the like; and ether alcohol compounds such as ethylene glycol monobutyl ether, ethylene glycol monoethyl ether and the like.

A mixing ratio of the unsaturated group-modified cationic epoxy resin (A) to the blocked polyisocyanate compound (B) is such that the resin (A) is in the range of 50 to 90% by weight and the blocked polyisocyanate compound (B) is in the range of 10 to 50% by weight based on a total solid content of the unsaturated group-modified cationic epoxy resin (A) and the blocked polyisocyanate compound (B).

Photopolymerization Initiator (C):

The photopolymerization initiator (C) may include, for example, benzoin, benzoin methyl ether, benzoin ethyl ether, benzoin isobutyl ether, diethoxyacetophenone, 2-hydroxy-2-methyl-1-phenylpropane-1-on, 2-benzyl-2-dimethylamino-1-(4-morpholinophenyl)-butanone, 2,4,6-trimethylbenzoylphenyl-phosphine oxide, 2,4,6-trimethylbenzoylphenylethoxyphosphine oxide, benzophenone, methyl, o-benzoyl benzoate, hydroxybenzophenone, 2-isopropyl-thioxanthone, 2,4-dimethylthioxanthone, 2,4-diethylthioxanthone, 2,4-dichlorothioxanthone, 2,4,6-tris(trichloromethyl)-S-triazine, 2-methyl-4,6-bis(trichloro)-S-triazine, 2-(4-methoxyphenyl)-4,6-bis(trichloromethyl)-S-triazine and the like.

Specifically, trade names of the photopolymerization initiator may include, for example, Cyracure UVI-6970, Cyracure UVI-6974, Cyracure UVI-6990, Cyracure UVI-6950 (marketed by USA Union Carbide Corp., trade names respectively), Irgacure 184, Irgacure 819, Irgacure 261 (marketed by Ciba Specialty Chemicals K.K., trade names respectively), SP-150, SP-170 (marketed by Asahi Denka Co., Ltd., trade names respectively), CG-24-61 (marketed by Ciba Specialty Chemicals K.K., trade name), CI-2734, CI-2758, CI-2855 (marketed by Nippon Soda Co., Ltd., trade names respectively), PI-2074 (marketed by Rhone-Poulenc S.A., trade name, pentafluorophenylborate toluylcumyl iodonium salt), FFC509 (marketed by 3M Co., Ltd., trade name), BBI102 (marketed by Midori Kagaku Co., Ltd., trade name) and the like.

These photopolymerization initiators may be used alone or in combination. A mixing amount of the photopolymerization initiator (C) is preferably in the range of 0.1 to 15% by weight, preferably 0.2 to 10% by weight based on a total solid content of the unsaturated group-modified cationic epoxy resin (A) and the blocked polyisocyanate compound (B) from the standpoint of photocurability.

The photopolymerization initiator (C) may be used in combination with a photosensitizer for the purpose of promoting the photopolymerization reaction. The photosensitizer used in combination may include, for example, a tertiary amines such as triethylamine, triethanolamine, methyldiethanolamine, methyl 4-dimethylaminobenzoate, ethyl 4-dimethylaminobenzoate, isoamyl 4-dimethylaminobenzoate, (2-dimethylamino)ethyl benzoate, Michler's ketone, 4,4′-diethylaminobenzophenone and the like; alkylphosphines such as triphenylphosphine and the like, thioethers such as thiodiglycol and the like, and the like.

The photosensitizers may be used alone or in combination. A mixing amount of the photosensitizer is in the range of 0 to 5% by weight based on a total solid content of the unsaturated group-modified cationic epoxy resin (A) and the blocked polyisocyanate crosslinking agent (B).

Polymerizable Unsaturated Group-Containing Compound (D):

The cationic coating composition may further contain a polymerizable unsaturated group-containing compound (D). The polymerizable unsaturated group-containing compound (D) is a compound having at least one radically polymerizable unsaturated group in one molecule, preferably at least two from the standpoint of curing properties.

The compound (D) specifically may include, for example, as a mono-functional polymerizable monomer, styrene, methyl (meth)acrylate, ethyl (meth)acrylate, butyl (meth)acrylate, 2-ethylhexyl (meth)acrylate, lauryl (meth)acrylate, cyclohexyl (meth)acrylate, cyclohexenyl (meth)acrylate, 2-hydroxyl (meth)acrylate, hydroxypropyl (meth)acrylate, tetrahydro-furfuryl (meth)acrylate, ε-caprolactone-modified tetrahydrofurfuryl (meth)acrylate, phenoxyethyl (meth)acrylate, phenoxy-polyethylene glycol (meth)acrylate, dicyclopentenyl (meth)acrylate, dicyclopentenyloxyethyl (meth)acrylate, isobornyl (meth)acrylate, benzyl (meth)acrylate, ε-caprolactone-modified hydroxyethyl (meth)acrylate, polyethylene glycolmono (meth)acrylate, polypropylene glycolmono (meth)acrylate, 2-hydroxy-3-phenoxypropyl (meth)acrylate, 2-hydroxy-3-butoxypropyl (meth)acrylate, monohydroxyethyl phthalate (meth)acrylate, Aronix M110 (trade name, marketed by Toagosei Chemical Industry Co., Ltd.), N-methylol (meth)acrylamide, N-methylol (meth)acrylamide butyl ether, acryloylmorpholine, dimethylaminoethyl (meth)acrylate, N-vinyl-2-pyrrolidone and the like; as bifunctional polymerizable monomer, for example, ethylene glycol di(meth)acrylate, diethylene glycol di(meth)acrylate, polyethylene glycol di(meth)acrylate, propylene glycol di(meth)acrylate, dipropylene glycol di(meth)acrylate, polypropylene glycol di(meth)acrylate, neopentyl glycol di(meth)acrylate, 1,4-butanediol di(meth)acrylate, 1,6-hexanediol di(meth)acrylate, bisphenol A ethylene oxide-modified di(meth)acrylate, bisphenol A propylene oxide-modified di(meth)acrylate, 2-hydroxy-1-acryloxy-3-methacryloxypropane, tricyclodecanedimethanol di(meth)acrylate, di(methiacryloyloxy-ethyl acid phosphate, Kayarad HX-220, 620, R-604, MANDA (trade name, marketed by Nippon Kayaku Co., Ltd., respectively), Photomer (trade name, marketed by Cognis Japan Ltd., epoxy oligomer), and the like; and as tri- or higher functional polymerizable monomer, for example, trimethylolpropane tri(meth)acrylate, trimethylolpropane ethylene oxide-modified tri(meth)acrylate, trimethylolpropane propylene oxide-modified tri(meth)acrylate, glycerin tri(meth)acrylate, glycerin ethylene oxide-modified tri(meth)acrylate, glycerin propylene oxide-modified tri(meth)acrylate, pentaerythritol tri(meth)acrylate, pentaerythritol tetra(meth)acrylate, isocyanuric acid ethylene oxide-modified triacrylate, dipentaerythritol, hexa(meth)acrylate, and the like. Of these, bi- or higher functional polymerizable monomers are preferable from the standpoints of photocurability, mar resistance and the like. These compounds may be used alone or in combination.

A mixing ratio of the unsaturated group-modified cationic epoxy resin (A), the blocked polyisocyanate crosslinking agent (B) and the polymerizable unsaturated group-containing compound (D) is such that the resin (A) is in the range of 20 to 90% by weight, the blocked polyisocyanate crosslinking agent (B) is in the range of 5 to 45% by weight, and the polymerizable unsaturated group-containing compound (D) is in the range of 0 to 45% by weight based on a total solid content of the unsaturated group-modified epoxy resin (A), the blocked polyisocyanate crosslinking agent (B) and the polymerizable unsaturated group-containing compound (D).

The cationic coating composition may preferably include a cationic electrodeposition coating composition obtained by a method, which comprises mixing the unsaturated group-modified epoxy resin (A), the blocked polyisocyanate crosslinking agent (B), the photopolymerization initiator (C), preferably the polymerizable unsaturated group-containing compound (D) and additives with sufficient agitation, followed by neutralizing with a water-soluble acid in a water based medium to make the epoxy resin water-soluble or water-dispersible.

Preferable examples of the acid used for neutralization may include an organic carboxylic acid such as acetic acid, formic acid and the like, preferably mixtures thereof. Use of the organic carboxylic acid for neutralization may improve finish properties and throwing power properties resulting from the coating composition, and coating composition stability.

The cationic coating composition of the present invention may contain a bismuth compound as an anticorrosive agent. The bismuth compound may not be particularly limited, but may include an inorganic bismuth compound such as bismuth oxide, bismuth hydroxide, basic carbonate bismuth, bismuth nitrate, bismuth silicate and the like. Of these, bismuth hydroxide is preferable.

The bismuth compound may also include an organic acid bismuth salt prepared by reacting at least two organic acid, at least one of which is aliphatic hydroxycarboxylic acid, with the above bismuth compound.

An organic acid used in preparation of the organic acid bismuth salt may include, for example, glycol acid, glycerin acid, lactic acid, dimethylolpropionic acid, dimethylol butyric acid, dimethylol valeric acid, tartaric acid, malic acid, hydroxymalonic acid, dihydroxysuccinic acid, trihydroxysuccinic acid, methyl malonic acid, benzoic acid, citric acid and the like.

These inorganic bismuth compounds and organic acid bismuth salts may be used alone or in combination.

A mixing amount of these bismuth compounds in the cationic coating composition of the present invention may not be particularly limited and may widely be varied depending on performances required for the coating composition, but is such that a bismuth content is in the range of 0 to 10 parts by weight, preferably 0.05 to 5 parts by weight per 100 parts by weight of the resin solid content in the coating composition.

The cationic coating composition of the present invention may optionally contain a tin compound as a curing catalyst. The tin compound may include, for example, an organic tin compound such as dibutyltin oxide, dioctyltin oxide and the like; aliphatic or aromatic carboxylic acid salt of dialkyltin, for example, dibutyltin dilaurate, dioctyltin dilaurate, dibutyltin diacetate, dioctyltin dibenzoate, dibutyltin dibenzoate and the like. Of these dialkyltin aromatic carboxylic acid salt is preferable.

A mixing amount of the above tin compounds in the cationic coating composition of the present invention may not particularly be limited and may widely be varied depending on performances required for the coating composition, but is such that a tin content is in the range of 0.01 to 8.0 parts by weight, preferably 0.05 to 5.0 parts by weight per 100 parts by weight of a resin solid content in the coating composition.

The cationic coating composition may optionally and preferably contain a modifying resin such as a xylene resin, acrylic resin and the like, and may optionally contain a coating composition additive such as a color pigment, extender pigment, anti-corrosive pigment, organic solvent, pigment dispersant, surface controlling agent and the like.

A coating method to form a coating film may include a cationic electrodeposition coating method, spray coating method, electrostatic coating method and the like.

The cationic electrodeposition coating may be carried out under conditions of a solid content concentration of about 5 to 40% by weight by diluting with deionized water, a pH in the range of 5.5 to 9.0, an electrodeposition coating bath temperature of 15 to 35° C. and a loading voltage of 100 to 400 V.

A cationic electrodeposition coating film thickness may not particularly be limited, but generally is in the range of 10 to 40 μm, particularly 15 to 35 μm as a cured coating film. Curing of the cationic electrodeposition coating film may be 0.20-carried out by the following methods, that is, (1) a method of subjecting a cationic electrodeposition coating film to irradiation followed by heating, (2) a method of subjecting a cationic electrodeposition coating film to heating followed by irradiation, (3) a method of subjecting a cationic electrodeposition coating film to irradiation and heating simultaneously, and (4) a method of subjecting a cationic electrodeposition coating film to irradiation only, followed by heating the resulting cationic electrodeposition coating film, and an intercoat coating film and/or a topcoat coating film simultaneously.

Curing by irradiation of the coating film may be carried out by irradiation of an ultraviolet light having a wave length of 200 to 450 nm. On irradiation of the ultraviolet light, an irradiation source having a highly sensitive wave length may be selected depending on a kind of the photopolymerization initiator. An irradiation source of the ultraviolet light may include, for example, high pressure mercury lamp, ultrahigh pressure mercury lamp, xenone lamp, carbon arc, metal halide lamp, sunlight and the like. Conditions of ultraviolet light irradiation onto the coating film are such that an irradiation dose is in the range of 100 to 5,000 mj/cm², preferably 500 to 3,000 mj/cm². An irradiation time of about several minutes makes it possible to cure the coating film.

Heat curing conditions are such that a surface temperature of the coating film is in the range of about 120 to about 200° C., preferably about 130 to about 180° C., and a heat curing time is about 5 to 60 minutes, preferably about 10 to 30 minutes.

Heat curing may also be carried out by a multi-layer coating film-forming method which comprises heat curing a cationic coating film or the cationic electrodeposition coating film, and an intercoat coating film and/or a topcoat coating film simultaneously.

Multi-Layer Coating Film-Forming Method

A multi-layer coating film-forming method, which comprises heat curing a cationic coating film, and an intercoat coating film and/or a topcoat coating film simultaneously, is explained hereinafter.

That is, the multi-layer coating film-forming method comprises the following successive steps (1) to (4):

a step (1) of coating the cationic coating composition as defined in any one of paragraphs 1 to 5 onto a coating substrate to form a cationic coating film,

a step (2) of subjecting the cationic coating film formed in the step (1) to irradiation,

a step (3) of coating an intercoat coating composition and/or a topcoat coating composition to form an intercoat coating film and/or a topcoat coating film, and

a step (4) of simultaneously heating and curing the cationic coating film, and the intercoat coating film and/or the topcoating film.

The above steps (1) to (4) are explained more in detail hereinafter.

The step (1) is a step of coating a cationic coating composition to form a cationic coating film. In the case where the cationic coating composition is a cationic electrodeposition coating composition, a cationic electrodeposition coating may be applied onto a coating substrate, for example, an automobile body, parts, electrical products, architectural material and the like, made of iron, aluminum, tin, zinc, alloys thereof and the like. These electrically conductive coating substrates are preferably subjected to a surface treatment with a zinc phosphate prior to coating the cationic electrodeposition coating composition from the standpoint of improving corrosion resistance.

The cationic electrodeposition coating film formed by the electrodeposition coating is washed with water, preferably followed by subjecting to preheating at a temperature of 60 to 120° C., setting at room temperature, air blowing and the like from the standpoints of improvements in finish properties and corrosion resistance.

The step (2) is a step of subjecting the cationic coating film to irradiation for crosslinking. The cationic coating film is crosslinked and cured by irradiation of an ultraviolet light having a wave length of 200 to 450 nm. On irradiation of the ultraviolet light, an irradiation source having a highly sensitive wave length may be selected depending on a kind of the photopolymerization initiator. An irradiation source of the ultraviolet light may include, for example, high pressure mercury lamp, ultrahigh pressure mercury lamp, xenone lamp, carbon arc, metal halide lamp, sunlight and the like. Conditions of ultraviolet light irradiation onto the coating film are such that an irradiation dose is in the range of 100 to 5,000 mj/cm², preferably 500 to 3,000 mj/cm². An irradiation time of about several minutes makes it possible to cure the coating film.

The step (3) is a step of coating an intercoat coating composition and/or a topcoat coating composition to form an intercoat coating film and/or a topcoat coating film. The intercoat coating composition and the topcoat-coating composition may include a water based, powder or organic solvent based ones. However, from the standpoint of measures to environment, a water based coating composition comprising a water dispersion on emulsion of an acrylic resin or polyester resin containing carboxyl group and hydroxyl group respectively is preferable. Nevertheless a water based intercoat coating composition and a water based topcoat coating composition are usually an anionic coating composition, curing of the cationic coating film by irradiation can prevent mixing or agglomeration between the cationic coating film, and the intercoat coating film and/or the topcoat coating film, resulting in making it possible to form an intercoat coating film and/or a topcoat coating film showing improved finish properties.

A base resin in the above water based coating composition may include any ones containing hydroxyl group and carboxyl group as known in the art, for example, polyester resin, acrylic resin, fluorocarbon resin, silicon-containing resin and the like. The base resin has a hydroxyl value of 30 to 200 mg KOH/g, particularly 50 to 150 mg KOH/g, an acid value of 10 to 100 mg KOH/g, particularly 15 to 75 mg KOH/g, a number average molecular weight of 1,000 to 100,000, particularly 5,000 to 50,000.

A crosslinking agent used in combination with the base resin may include, for example, melamine resin, urea resin, benzoguanamine resin, methyloled product thereof, etherified amino resin obtained by etherifying a part of all of the methyloled product with mono-alcohol having 1 to 8 carbon atoms, and blocked polyisocyanate.

The water based coating composition may optionally contain a color pigment, extender pigment, ultraviolet light absorber and the like. A mixing amount of the pigment is 0 to 150 parts by weight per 100 parts by weight of a total weight of the base resin and the crosslinking agent.

The intercoat coating composition and/or the topcoat coating composition are prepared by mixing and dispersing the base resin and the crosslinking agent, with water respectively. A mixing ratio to water may not particularly be limited, but mixing is preferably be carried out so that a solid content on coating can be in the range of 15 to 60% by weight. The topcoat coating composition may optionally contain a color pigment, metallic pigment, extender pigment, ultraviolet light absorber and the like.

The intercoat coating composition and/or the topcoat coating composition may be coated by at least one layer respectively by a coating method such as an air spray coating, airless spray coating, rotary spray coating or electrostatic coating and the like so as to a film thickness of about 10 to 50 μm.

The step (4) is a step of simultaneously heating and curing the cationic coating film, and the intercoat coating film and/or the topcoat coating film at a heating temperature of about 100 to 200° C., preferably about 120 to 180° C. for 1 to 120 minutes, preferably 10 to 30 minutes.

A heating method may include a direct or indirect hot air drying method by use of an electric furnace, gas furnace and the like, a heating method by use of infrared rays and far infrared rays, a dielectric heating method by use of high frequency, and the like. As measures to refuse and dust, the multi-layer coating film comprising the cationic coating film, and the intercoat coating film and/or the topcoat coating film can be heated and cured by subjecting to the heating method by use of infrared rays and far infrared rays, followed by subjecting to the hot air drying method.

The present invention can provide the following particular effects.

In the case where the cationic electrodeposition coating composition is used as the cationic coating composition of the present invention, in a coating line of a part, for example, a frame in the shape of an even plate, rod and the like, the use of both irradiation and heating in the crosslinking reaction of the electrodeposition coating film makes possible reduction in steps and energy savings, resulting in making it possible to reduce exhaust gas, gum and soot from the drying oven.

The multi-layer coating film-forming method of the present invention prevents mixing between the cationic coating film, and the intercoat coating film and/or the topcoat coating film, and makes possible improvements in finish properties and corrosion resistance, resulting making possible omission of heating of the cationic coating film only, reduction in steps, energy savings and the like.

The present invention is preferably applicable to the automobile coating.

### EXAMPLE

The present invention will be explained more in detail by the following Examples and Comparative Examples, in which “part” and “%” mean “part by weight” and “% by weight” respectively. The present invention should not be limited thereto.

### Preparation Example 1

(Preparation of Unsaturated Group-Modified Cationic Epoxy Resin No. 1)

A mixture of 1010 g of Epikote 828 EL (trade name, marketed by Japan Epoxy Resin Co., Ltd., epoxy resin), 390 g of bisphenol A and 0.2 g of dimethylbenzylamine was reacted at 130° C. so as to be an epoxy equivalent of 800, followed by adding 36 g of acrylic acid, 0.1 g of hydroquinone, 105 g of diethanolamine and 65 g of a ketiminized product of diethylenetriamine, reacting at 120° C. for 4 hours, and adding 347 g of butylcellosolve to obtain an unsaturated group-modified cationic epoxy resin No. 1 having an amine value of 50 mg KOH/g, an unsaturation equivalent of 3100, and a solid content of 80%.

### Preparation Example 2

(Unsaturated Group-Modified Cationic Epoxy Resin No. 2)

A 21-separable flask equipped with a thermometer, reflux condenser and stirrer was charged with 240 g of 50% formalin, 55 g of phenol, 10 μg of 98% technical sulfuric acid and 212 g of m-xylene, followed by reacting at 84 to 88° C. for 4 hours, leaving at rest to separate a resin phase from a sulfuric acid water phase, washing the resin phase with water three times, and stripping unreacted m-xylene under the condition of 20-30 mmHg/120-130° C. to obtain 240 g of a phenol-modified xylene formaldehyde resin having a viscosity of 1050 centipoise (25° C.)

Next, another flask was charged with 1000 g of Epikote 828 EL (trade name, marketed by Japan Epoxy Resin Co., Ltd., epoxy resin, epoxy equivalent 190, molecular weight 350), 400 g of bisphenol A and 0.2 g of dimethylbenzylamine, followed by reacting at 130° C. so as to be an epoxy equivalent of 750, adding 200 g of the phenol-modified xylene formaldehyde resin, 36 g of acrylic acid, 0.1 g of hydroquinone, 95 g of diethanolamine and 65 g of a ketiminized product of ethylenetriamine, reacting at 120° C. for 4 hours, and adding 394 g of butylcellosolve to obtain an unsaturated group-modified cationic epoxy resin No. 2 having an amine value of 41 mg KOH/g, an unsaturation equivalent of 3500 and a resin solid content of 80%.

### Preparation Example 3

(Preparation Example of amino group-containing epoxy resin No. 1)

A mixture of 1010 g of Epikote 828 EL (trade name, marketed by Japan Epoxy Resin Co., Ltd., epoxy resin), 390 g of bisphenol A and 0.2 g of dimethylbenzylamine was reacted at 130° C. so as to be an epoxy equivalent of 800, followed by adding 160 g of diethanolamine and 65 g of a ketiminized product of diethylenetriamine, reacting at 120° C. for 4 hours, adding 355 g of butylcellosolve to obtain an amino group-containing epoxy resin having an amine value of 67 mg KOH/g, and a solid content of 80%.

### Preparation Example 4

(Preparation of Crosslinking Agent No. 1)

A reactor was charged with 222 g of isophorone diisocyanate and 99 g of methyl isobutyl ketone, followed by heating up to 50° C., slowly adding 174 g of methylethylketoxime heating up to 60° C., sampling with time while keeping at that temperature and confirming that absorption of unreacted isocyanate disappeared by an infrared absorption spectral measurement to obtain a crosslinking agent No. 1 having a solid content of 80%.

### Preparation Example 5

(Preparation of Emulsion No. 1)

A mixture of 100 g (80 g as resin solid content) of the unsaturated group-modified cationic epoxy resin No. 1, 25 g (20 g as resin solid content) of curing agent No. 1, 3 g of Irgacure 184 (Note 2), 5 g of Irgacure 819 (Note 3) and 15 g of 10% acetic acid was uniformly stirred, followed by dropping 170 g of deionized water over about 15 minutes while strongly stirring to obtain an emulsion No. 1 having a solid content of 34%.

### Preparation Examples 6-9

(Preparation of Emulsions No. 2 to No. 5)

Preparation Example 5 was duplicated except that formulations shown in Table 1 were used respectively to obtain emulsions No. 2 to No. 5. In Table 1, the solid content is parenthesized.

TABLE 1

| | Prepa- | Prepa- | Prepa- | Prepa- | Prepa- |
|---|---|---|---|---|---|
| | ration | ration | ration | ration | ration |
| | Example | Example | Example | Example | Example |
| | 5 | 6 | 7 | 8 | 9 |
| Emulsion | No. 1 | No. 2 | No. 3 | No. 4 | No. 5 |
| Unsaturated group-containing | 100 | | 62.5 | | |
| cationic epoxy resin No. 1 | (80) | | (50) | | |
| Unsaturated group-containing | | 100 | | | |
| cationic epoxy resin No. 2 | | (80) | | | |
| Photomer 3016 (Note 1) | | | 30 | | |
| | | | (30) | | |
| Amino group-containing | | | | 100 | 87.5 |
| epoxy resin | | | | (80) | (70) |
| Crosslinking agent | 25 | 25 | 27.5 | 25 | 37.5 |
| | (20) | (20) | (20) | (20) | (30) |
| Irgacure 184 (Note 2) | 3 | 3 | 3 | 3 | 0 |
| Irgacure 819 (Note 3) | 5 | 5 | 5 | 5 | 0 |
| 10% acetic acid | 15 | 15 | 15 | 15 | 15 |
| Deionized water | 170 | 170 | 175 | 170 | 154 |
| 34% emulsion | 318 | 318 | 318 | 318 | 294 |
| | (108) | (108) | (108) | (108) | (100) |

(Note 1)
Photomer 3016 (trade name, marketed by Cognis Japan Ltd., epoxyoligomer).
(Note 2)
Irgacure 184 (trade name, marketed by Ciba-Geigy Japan Ltd., photopolymerization initiator).
(Note 3)
Irgacure 819 (trade name, marketed by Ciba-Geigy Japan Ltd., photopolymerization initiator).

### Preparation Example 10

(Preparation of Pigment-Dispersed Paste)

To a mixture of 5.83 parts (solid content 3.5 parts) of 60% solid content quaternary ammonium salt type epoxy resin, 5 parts of titanium white and 2.0 parts of bismuth hydroxide was added 6.3 parts of deionized water, followed by sufficiently stirring to obtain a pigment-dispersed paste having a solid content of 55%.

### Example 1

To 294 parts (solid content 100 parts) of Emulsion No. 1 were added 11.5 parts (solid content 6.3 parts) of the pigment-dispersed paste, and 226 parts of deionized water to obtain a cationic electrodeposition coating composition No. 1 having a solid content of 20%.

### Examples 2-4 and Comparative Examples 1-3

Example 1 was duplicated except that respective formulations shown in Table 2 were used to obtain cationic electrodeposition coating compositions No. 2 to No. 7 having a solid content of 20% respectively. In Table 2, the solid content is parenthesized.

TABLE 2

| | | | | | Compar- | Compar- | Compar- |
|---|---|---|---|---|---|---|---|
| | | | | | ative | ative | ative |
| Cationic | Example | Example | Example | Example | Example | Example | Example |
| electrodeposition | 1 | 2 | 3 | 4 | 1 | 2 | 3 |
| coating composition | No. 1 | No. 2 | No. 3 | No. 4 | No. 5 | No. 6 | No. 7 |
| Emulsion No. 1 | 318 | | | 318 | | | |
| (solid content 34%) | (108) | | | (108) | | | |
| Emulsion No. 2 | | 318 | | | | | |
| (solid content 34%) | | (108) | | | | | |
| Emulsion No. 3 | | | 318 | | | | |
| (solid content 34%) | | | (108) | | | | |
| Emulsion No. 4 | | | | | 318 | | 318 |
| (solid content 34%) | | | | | (108) | | (108) |
| Emulsion No. 5 | | | | | | 294 | |
| (solid content 34%) | | | | | | (100) | |
| Pigment dispersed | 49.8 | 49.8 | 49.8 | | 49.8 | 49.8 | |
| paste | (6.3) | (6.3) | (6.3) | | (6.3) | (6.3) | |
| (solid content 55%) | | | | | | | |
| Deionized water | 203.7 | 203.7 | 203.7 | 222 | 203.7 | 187.7 | 222 |
| 20% Coating | 571.5 | 571.5 | 571.5 | 540 | 571.5 | 531.5 | 540 |
| composition | (114.3) | (114.3) | (114.3) | (108) | (114.3) | (106.3) | (108) |

Water Based Intercoat Coating Composition:

WP-300T (trade name, marketed by Kansai Paint Co., Ltd., water based intercoat coating composition) was used.

### Preparation Example 11

(Preparation of Water Based Topcoat Coating Composition)

To a mixture of 70 parts of acrylic resin (hydroxyl value 60 mg KOH/g, acid value 35 mg KOH/g, number average molecular weight 6,000), 30 parts of butyl etherified melamine and dimethylethanolamine as a neutralizing agent was added 60 parts of JR-806 (trade name, marketed by Tayca Corporation, titanium oxide), followed by mixing to obtain a water based topcoat coating composition.

Coating Substrate:

A cold-rolled steel plate (70×150×0.8 mm) chemically treated with Palbond #3020 (trade name, marketed by Nippon Parkerizing Co., Ltd., zinc phosphate treating agent) was used as a coating substrate.

### Example 5

The cationic electrodeposition coating composition No. 1 was coated so as to a film thickness of 20 em, followed by washing with water, preheating at 80° C. for 10 minutes, subjecting to irradiation of ultraviolet light from a 120 W/cm metal halide lamp at an irradiation dose of 2000 mj/cm² for 10 seconds for photocuring, and heating at 140° C. for 10 minutes to obtain a cured mono-layer coating film.

### Examples 6-8

Cationic electrodeposition coating compositions No. 2 to No. 4 were used in place of cationic electrodeposition coating composition No. 1 in Example 5, and were subjected to the conditions shown in Table 3 to obtain respective cured mono-layer films.

### Example 9

The cationic electrodeposition coating composition No. 1 was coated so as to be a film thickness of 20 μm, followed by washing with water, preheating at 100° C. for 5 minutes, subjecting to irradiation of ultraviolet light from a 120 W/cm metal halide lamp at an irradiation dose of 2000 mj/cm² for 10 seconds for photocuring, coating a water based intercoat coating composition, WP-300T (trade name as above mentioned) so as to be a film thickness of 35 μm, coating the topcoat coating composition obtained in Preparation Example 11 so as to be a film thickness of 35 μm, and heating three coating films simultaneously to obtain a cured multi-layer coating film.

### Comparative Example 4

The cationic electrodeposition coating composition No. 1 was coated so as to be a film thickness of 20 μm, followed by washing with water, and heating at 140° C. for 10 minutes without subjecting to irradiation to form a cured mono-layer coating film.

### Comparative Example 5

The cationic electrodeposition coating composition No. 5 was coated so as to be a film thickness of 20 μm, followed by washing with water, and heating at 140° C. for 10 minutes without subjecting to irradiation to form a cured mono-layer coating film.

### Comparative Example 6

The cationic electrodeposition coating composition No. 5 was coated so as to be a film thickness of 20 μm, followed by washing with water, and heating at 170° C. for 20 minutes without subjecting to irradiation to form a cured mono-layer coating film.

### Comparative Example 7

The cationic electrodeposition coating composition No. 6 was coated so as to be a film thickness of 20 μm, followed by washing with water, and heating at 170° C. for 20 minutes without subjecting to irradiation to form a cured mono-layer coating film.

### Comparative Example 8

The cationic electrodeposition coating composition No. 7 was coated so as to be a film thickness of 20 μm, followed by washing with water, and heating at 170° C. for 20 minutes without subjecting to irradiation to form a cured mono-layer coating film.

### Comparative Example 9

The cationic electrodeposition coating composition No. 1 was coated so as to be a film thickness of 20 μm, followed by washing with water, preheating at 100° C. for 5 minutes, coating the water based intercoat coating composition, WP-300T (trade name as above mentioned) so as to be a film thickness of 35 μm, coating the topcoat coating composition obtained in Preparation Example 11 so as to be a film thickness of 35 μm, and heating three coating films simultaneously to obtain a cured multi-layer coating film.

### Comparative Example 10

Comparative Example 9 was duplicated except that the cationic electrodeposition coating composition No. 6 was used to obtain a cured multi-layer coating film consisting of three coating films.

Mono-layer coating film-forming methods or multi-layer coating film-forming methods in Examples 5-9 and Comparative Examples 4-10 are shown in Table 3.

TABLE 3

| | | | | | | | | | | | | | Compar- | |
|---|---|---|---|---|---|---|---|---|---|---|---|---|---|---|
| | | | | | | | | | | | | | ative | |
| | | | Exam- | | Exam- | | Exam- | | | | Exam- | | Exam- | |
| | | | ple | | ple | | ple | | Exam- | | ple | | ple | |
| | | | 5 | | 6 | | 7 | | ple | | 9 | | 4 | |
| | | | mono- | | mono- | | mono- | | 8 | | multi- | | mono- | |
| | | | layer | | layer | | layer | | clear | | layer | | layer | |
| | | | coating | | coating | | coating | | coating | | coating | | coating | |
| Coating film | | | film | | film | | film | | film | | film | | film | |
| Step 1 | Cationic | | No. | 1 | No. | 2 | No. | 3 | No. | 4 | No. | 1 | No. | 1 |
| | electro- | | | | | | | | | | | | | |
| | deposition | | | | | | | | | | | | | |
| | coating | | | | | | | | | | | | | |
| | composition | | | | | | | | | | | | | |
| | Pre- | ° C. | 80° | C. | 80° | C. | 80° | C. | 80° | C. | 100° | C. | none | |
| | heating | hour | 10 | min. | 10 | min. | 10 | min. | 10 | min. | 5 | min. | none | |
| Step 2 | photo- | W/cm | 120 | | 120 | | 120 | | 120 | | 120 | | none | |
| | curing | mJ/cm² | 2000 | | 2000 | | 2000 | | 2000 | | 2000 | | none | |
| | | irradi- | 10 | sec. | 10 | sec. | 10 | sec. | 10 | sec. | 10 | sec. | none | |
| | | ation | | | | | | | | | | | | |
| | | time | | | | | | | | | | | | |
| | heating | ° C. | 140° | C. | 140° | C. | 140° | C. | 140° | C. | none | | 140° | C. |
| | | hour | 10 | min. | 10 | min. | 10 | min. | 10 | min. | none | | 10 | min. |
| Step 3 | intercoat | | | | | | | | | | 35 | μm | | |
| | coating film | | | | | | | | | | | | | |
| | thickness | | | | | | | | | | | | | |
| | topcoat coating | | | | | | | | | | 35 | μm | | |
| | film thickness | | | | | | | | | | | | | |
| Step 4 | heating | ° C. | | | | | | | | | 140° | C. | | |
| | | hour | | | | | | | | | 20 | min. | | |
| | | | Compar- | | Compar- | | Compar- | | | | Compar- | | Compar- | |
| | | | ative | | ative | | ative | | Compar- | | ative | | ative | |
| | | | Exam- | | Exam- | | Exam- | | ative | | Exam- | | Exam- | |
| | | | ple | | ple | | ple | | Exam- | | ple | | ple | |
| | | | 5 | | 6 | | 7 | | ple | | 9 | | 10 | |
| | | | mono- | | mono- | | mono- | | 8 | | multi- | | multi- | |
| | | | layer | | layer | | layer | | clear | | layer | | layer | |
| | | | coating | | coating | | coating | | coating | | coating | | coating | |
| Coating film | | | film | | film | | film | | film | | film | | film | |
| Step 1 | Cationic | | No. | 5 | No. | 5 | No. | 6 | No. | 7 | No. | 1 | No. | 6 |
| | electro- | | | | | | | | | | | | | |
| | deposition | | | | | | | | | | | | | |
| | coating | | | | | | | | | | | | | |
| | composition | | | | | | | | | | | | | |
| | Pre- | ° C. | none | | none | | none | | none | | 100° | C. | 100° | C. |
| | heating | hour | none | | none | | none | | none | | 5 | min. | 5 | min. |
| Step 2 | photo- | W/cm | none | | none | | none | | none | | none | | none | |
| | curing | mJ/cm² | none | | none | | none | | none | | none | | none | |
| | | irradi- | none | | none | | none | | none | | none | | none | |
| | | ation | | | | | | | | | | | | |
| | | time | | | | | | | | | | | | |
| | heating | ° C. | 140° | C. | 170° | C. | 170° | C. | 170° | C. | none | | none | |
| | | hour | 10 | min. | 20 | min. | 20 | min. | 20 | min. | none | | none | |
| Step 3 | intercoat | | | | | | | | | | 35 | μm | 35 | μm |
| | coating film | | | | | | | | | | | | | |
| | thickness | | | | | | | | | | | | | |
| | topcoat coating | | | | | | | | | | 35 | μm | 35 | μm |
| | film thickness | | | | | | | | | | | | | |
| Step 4 | heating | ° C. | | | | | | | | | 140° | C. | 140° | C. |
| | | hour | | | | | | | | | 20 | min. | 20 | min. |

Table 4 shows film performances of mono-layer electrodeposition coating films obtained in Examples 5-8 and Comparative Examples 4-8.

TABLE 4

| | | | | | | Compar- | Compar- | Compar- | Compar- | Compar- |
|---|---|---|---|---|---|---|---|---|---|---|
| | | Exam- | Exam- | Exam- | Exam- | ative | ative | ative | ative | ative |
| | | ple | ple | ple | ple | Exam- | Exam- | Exam- | Exam- | Exam- |
| | | 5 | 6 | 7 | 8 | ple 4 | ple 5 | ple 6 | ple 7 | ple 8 |
| Mono- | gel | 95 | 96 | 96 | 98 | 58 | 72 | 87 | 94 | 87 |
| layer | fraction | | | | | | | | | |
| electro- | (%) | | | | | | | | | |
| deposi- | (Note 4) | | | | | | | | | |
| tion | heating | 4.4 | 4.5 | 5.6 | 6.2 | 5.5 | 5.7 | 6.4 | 8.6 | 9.1 |
| coating | loss | | | | | | | | | |
| film | (Note 5) | | | | | | | | | |
| | corrosion | 2.1 | 2.1 | 2.4 | 2.9 | 6.3 | 5.9 | 3.2 | 2.1 | 4.8 |
| | resistance | | | | | | | | | |
| | (mm) (Note 6) | | | | | | | | | |
| (Note 4) | | | | | | | | | | |
| Gel fraction was measured according to the following steps (1) to (3). | | | | | | | | | | |
| Step (1): a step of measuring a weight \mathring{1} of a test panel. | | | | | | | | | | |
| Step (2): a step of carrying out electrodeposition coating by 20 μm, followed by measuring a weight \mathring{2} of a cured | | | | | | | | | | |
| # coating film. | | | | | | | | | | |
| Step (3): a step of dipping respective test panels into acetone at 20° C. for 24 hours, followed by drying at room temperature, | | | | | | | | | | |
| # and measuring a resulting weight \mathring{3}. A gel fraction was determined according to the following formula (1) from respective | | | | | | | | | | |
| # weights measured in steps (1) to (3). The higher, the better curing properties is. | | | | | | | | | | |
| Gel fraction = {(\mathring{3} − \mathring{1})/(\mathring{2} − \mathring{1})} × 100 . . . (1) | | | | | | | | | | |
| (Note 5) | | | | | | | | | | |
| Heating Loss: | | | | | | | | | | |
| Heating loss was determined by the method comprising steps (1) to (3): | | | | | | | | | | |
| step (1) of measuring a weight \mathring{1} of a test panel; step (2) of measuring a weight \mathring{2} of a coating film and the | | | | | | | | | | |
| # test panel; and step (3) of curing a coating film by mono-layer film-forming methods of Examples 5-7 and Comparative Examples 4-6, | | | | | | | | | | |
| # followed by measuring a weight \mathring{3} of a cured coating film and test panel. That is, the heating loss was determined according | | | | | | | | | | |
| # to the following formula (2): Heating loss (%) = {(\mathring{2} − \mathring{3})/(\mathring{2} − \mathring{1})} × 100 . . . (2) | | | | | | | | | | |
| Corrosion Resistance: | | | | | | | | | | |
| Cross cuts were formed by use of a knife on the surface of a mono-layer electrodeposition reacting film-coated test panel so as to | | | | | | | | | | |
| # reach the coating substrate, followed by subjecting to a 840 hours salt water spray test, and evaluating development of rust from the | | | | | | | | | | |
| # cross cut, and width of blisters as follows. | | | | | | | | | | |

good: maximum width of rust and blisters less than 3 mm from cut (one side)
fair: maximum width of rust and blisters 3 mm or more less than 4 mm from cut (one side)
poor: maximum width of rust and blisters 4 mm or more from cut (one side)

Table 5 shows performances of multi-layer coating films obtained in Example 9, and Comparative Examples 9 and 10.

TABLE 5

| | | | Comparative | Comparative |
|---|---|---|---|---|
| | | Example 9 | Example 9 | Example 10 |
| Multi-layer | specular | 91 | 60 | 65 |
| coating | reflectance | | | |
| film | (Note 7) | | | |
| | water | ∘ | x | x |
| | resistance | | | |
| | (Note 8) | | | |

(Note 7)
Specular Reflectance (%): A multi-layer coating film-coated test panel was subjected to a 60° specular gloss measurement in accordance with JIS K-5400.
(Note 8)
Water resistance: A multi-layer coating film-coated test panel was introduced into a blister box at 50° C., followed by taking out the test panel 240 hours after, drying at room temperature for 2 hours, forming 100 cut squares at an interval of 2 mm, applying a vinyl tape thereonto, strongly peeling off the tape, and examining a number of remaining squares for evaluating as follows.
∘: number of remaining squares: 100
Δ: number of remaining squares: 90-99
x: number of remaining squares: less than 90

What is claimed is:

1. A cationic coating composition containing (A) an unsaturated group-modified cationic epoxy resin, (B) a blocked polyisocyanate crosslinking agent, and (C) a photopolymerization initiator.

2. A cationic coating composition as claimed in claim 1, wherein the unsaturated group-modified cationic epoxy resin (A) is obtained by reacting an epoxy resin (a) having an epoxy equivalent of 180 to 2500 with an unsaturated group-containing compound (b) and a cationic group-containing compound (c).

3. A cationic coating composition as claimed in claim 1, wherein the unsaturated group-modified cationic epoxy resin (A) has an unsaturated group equivalent of 6000 or less.

4. A cationic coating composition as claimed in claim 1, wherein the epoxy resin (a) in the unsaturated group-modified cationic epoxy resin (A) is obtained by reacting a polyphenol compound and an epihalohydrin.

5. A cationic coating composition as claimed in claim 1, wherein the cationic coating composition further contains a polymerizable unsaturated group-containing compound (D).

6. A mono-layer coating film-forming method, which comprises subjecting a cationic electrodeposition coating composition as the cationic coating composition as claimed in any one of claims 1 to 5 to an electrodeposition coating to form an electrodeposition coating film, followed by subjecting the electrodeposition coating film to both irradiation and heating to form a cured mono-layer coating film.

7. A multi-layer coating film-forming method which comprises the following successive steps (1) to (4):
a step (1) of coating the cationic coating composition as claimed in any one of claims 1 to 5 onto a coating substrate to form a cationic coating film,
a step (2) of subjecting the cationic coating film formed in the step (1) to irradiation,
a step (3) of coating an intercoat coating composition and/or a topcoat coating composition to form an intercoat coating film and/or a topcoat coating film, and
a step (4) of simultaneously heating and curing the cationic coating film, and the intercoat coating film and/or the topcoating film.

8. A multi-layer coating film-forming method as claimed in claim 7, wherein the cationic coating film formed by the step (1) in claim 7 is preheated at a temperature of 60 to 120° C.

9. A multi-layer coating film-forming method as claimed in claim 7, wherein the cationic coating composition is a cationic electrodeposition coating composition.

10. A coated product obtained by any one of the methods as claimed in claims 6 to 9.
